(19) United States
(12) Patent Application Publication
(10) Pub. No.: US 2025/0389454 A1
(43) Pub. Date: Dec. 25, 2025

(54) Preformed Mirror Sandwich Reflectors for Concentrating Solar Thermal Energy

(71) Applicant: SunCatch Ltd., Evergreen, CO (US)

(72) Inventor: Sergey V. Khlop, Evergreen, CO (US)

(21) Appl. No.: 18/633,873

(22) Filed: Apr. 12, 2024

Related U.S. Application Data
(60) Provisional application No. 63/508,631, filed on Jun. 16, 2023.

(51) Int. Cl. F24S 23/74; B32B 5/18; B32B 15/04; B32B 15/18; B32B 17/06; B32B 27/06; B32B 27/30; F24S 30/425; F24S 60/00; F24S 80/00

(52) U.S. Cl. CPC F24S 23/74; B32B 5/18; F24S 30/425; F24S 80/00; B32B 15/046; B32B 15/18; B32B 17/066; B32B 27/065; B32B 27/308; B32B 2266/08; B32B 2307/416; F24S 60/00

(57) ABSTRACT

Due to its ability to deliver direct-from-solar thermal energy without conversion, and the low-temperature nature of technology, Concentrating Solar Thermal (CST) technology is less complex, less expensive, and therefore most suitable among Solar Thermal Energy (STE) technologies for residential and small business heating, hot water, and other thermal energy applications. The presently disclosed technology is focused on systems and methods for successfully scaling CST technology, including novel and inventive construction techniques, arrangements, and materials. Scaling CST technology allows for it to be more affordable, easy to install, easy to maintain, and easy to operate, even in smaller-scale installations, such as at a residence or small business.

### CROSS-REFERENCE TO RELATED APPLICATIONS

The present application claims benefit of priority to U.S. Provisional Patent Application No. 63/508,631 entitled “Scalable Concentrating Solar Thermal Energy,” and filed on Jun. 16, 2023, which is specifically incorporated by reference herein for all that it discloses or teaches.

### GOVERNMENT LICENSE RIGHTS

This invention was made with government support under Award No. 2021-33610-35723 awarded by the United States Department of Agriculture/National Institute of Food and Agriculture. The United States government has certain rights in the invention.

### BACKGROUND

Photovoltaics (PV) is the conversion of light into electricity using semiconducting materials that exhibit the photovoltaic effect. A photovoltaic system employs solar modules, each comprising a number of solar cells, which generate electrical power. While useful for generating electricity, PV systems are not ideal for fulfilling heating requirements as the generated electricity must be subsequently converted to thermal energy, with an associated loss (e.g., approximately 25% efficiency).

Solar Thermal Energy (STE) is a form of energy and a technology for harnessing solar energy to generate thermal energy for use in industry, and in residential and commercial sectors. Sunlight reflected off a mirrored reflector concentrates on a collector filled with a heat transfer fluid that absorbs heat and transfers it to the consumer. STE technologies can be utilized as a source of heat or when directed through the steam turbine, can be used to generate electric power. Two categories of STE are generally Concentrating Solar Thermal (CST) for fulfilling heating requirements and Concentrating Solar Power (CSP) when the heat collected is used for electric power generation.

Traditionally, STE technologies are represented by CSP at a utility scale. CSP technology often utilizes specialized materials and construction techniques that are difficult and extremely expensive to reproduce at smaller-scale installations, and therefore can be unsuitable for residential and small business sectors. Due to its ability to deliver direct-from-solar thermal energy without conversion, and the low-temperature nature of technology (e.g., below 220° C.), CST technology is less complex, less expensive, and therefore most suitable among STE for residential and small business heating, hot water, and other thermal energy applications.

### SUMMARY

Implementations described and claimed herein address the problems discussed below by providing a preformed sandwich mirror reflector comprising a backer panel, a reflector panel arranged parallel to the backer panel, and a cured closed-cell foam adhered to the backer panel and the reflector panel. The cured closed-cell pour foam has a predefined thickness between the backer panel and the reflector panel. The cured closed-cell foam may define a predefined curvature of the backer panel and the reflector panel. Further, the predefined curvature of the backer panel may be the same as the predefined curvature of the reflector panel. Other implementations are also described and recited herein.

### BRIEF DESCRIPTION OF THE DRAWINGS

FIG. 1 illustrates a schematic diagram of an example Concentrating Solar Thermal (CST) system adopting preformed mirror sandwich reflectors according to the presently disclosed technology.

FIG. 2 illustrates a preformed mirror sandwich reflector manufactured using the presently disclosed technology.

FIG. 3 illustrates a press-form in an open orientation for preformed mirror sandwich reflector production for a Concentrating Solar Thermal (CST) system according to the presently disclosed technology.

FIG. 4 illustrates the press-form of FIG. 3 in a closed orientation.

FIG. 5 illustrates a partial underside view showing heating and vacuum lines within an example lower section of a press-form for preformed mirror sandwich reflector production.

FIG. 6 illustrates an example latching mechanism for a press-form for preformed mirror sandwich reflector production.

FIG. 7 illustrates an example installation of a Concentrating Solar Thermal (CST) system according to the presently disclosed technology.

FIG. 8 illustrates a preformed mirror sandwich reflector installation system and method for a Concentrating Solar Thermal (CST) system according to the presently disclosed technology.

FIG. 9 illustrates a thermal energy storage reservoir for a Concentrating Solar Thermal (CST) system according to the presently disclosed technology.

FIG. 10 illustrates example operations for manufacturing a preformed sandwich mirror reflector.

### DETAILED DESCRIPTION

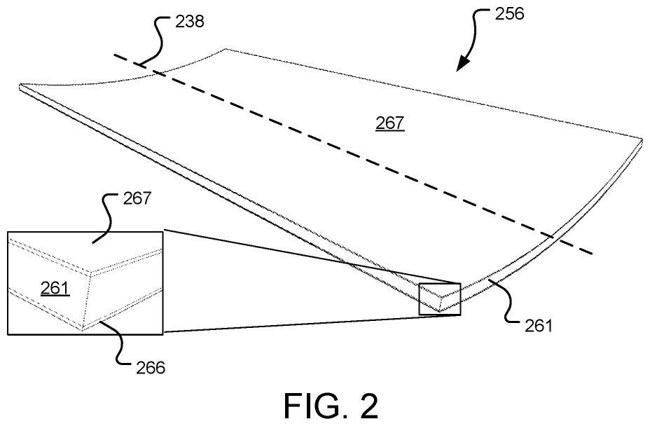

The presently disclosed technology is focused on systems and methods for successfully scaling CST technology, including novel and inventive construction techniques, arrangements, and materials. Scaling CST technology allows for it to be more affordable, easy to install, easy to maintain, and easy to operate, even in smaller-scale installations, such as at a residence or small business. Predefined thickness or curvature as used herein is preset by the respective curvatures of the reflector and backer panels discussed below and the gap therebetween in a press form for manufacturing. Constant or uniform curvature is used herein to describe dimensions that vary by less than 1% or approximately 0.1% over a surface area of a preformed mirror sandwich reflector (e.g., preformed mirror sandwich reflector 256 of FIG. 2). In various implementations, the foregoing predefined thicknesses and curvatures may or may not be uniform.

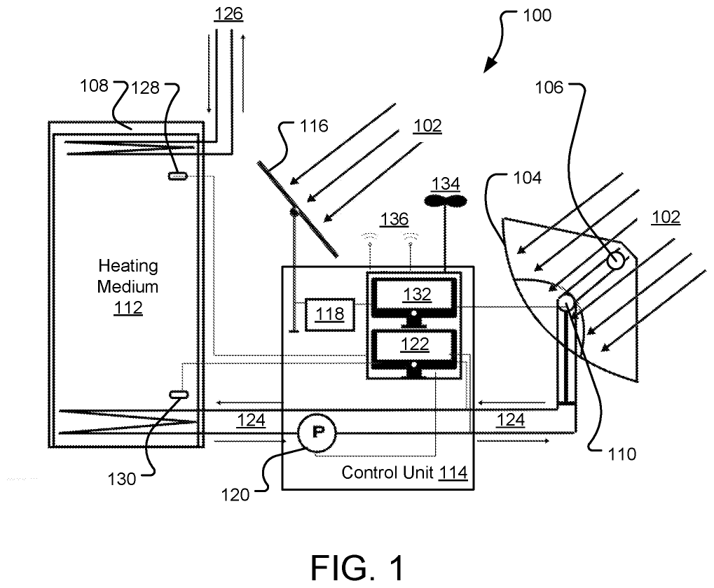

FIG. 1 illustrates a schematic diagram of an example Concentrating Solar Thermal (CST) system 100 adopting preformed mirror sandwich reflectors according to the presently disclosed technology. Sunlight 102 is directed on a concave reflector 104 that extends longitudinally into the page. The reflector 104 is made up of a series of preformed mirror sandwich reflector panels, as further described below with reference to FIG. 2. The reflector 104 directs the solar energy on a collector 106 (also referred to as a receiver or absorber), which takes the form of a pipe positioned along a focal axis of the reflector 104. The reflector 104 may be described as a parabolic (curved and mirrored) trough that reflects solar radiation onto the collector 106 (e.g., a tube containing a heat transfer fluid running the length of the trough, positioned along the focal axis of the reflector 104). The trough is parabolic along one axis and linear in the orthogonal axis. The reflector 104 is pre-shaped to a particular radius to ensure a precise focus of solar energy onto the collector 106.

A tracking system that follows the position of the sun allows the focal axis of the reflector 104 to remain on the collector 106 throughout the day. To maintain focus of the sunlight on the collector 106 throughout the day, the trough rotates about drive shaft 110, which may be mounted in an east-west direction. In some implementations, seasonal changes in the angle of sunlight parallel to the trough may not require adjustment of the mirrors since the light is simply concentrated elsewhere along the linear axis of the trough. Thus, the tracking system may only track and adjust the angle of the reflector 104 along the singular axis of the drive shaft 110. In other implementations, a controller module may monitor day and/or seasonal changes in the angle of incidence of sunlight and automatically adjust the reflector 104 angle to maintain the focal axis on the collector 106.

The collector 106 is filled with a heat transfer fluid and is a part of a supply heat transfer loop 124 extending from the collector 106 to a Thermal Energy Storage (TES) unit 108. The heat transfer fluid circulates through the collector 106, absorbs the heat from the concentrated sunlight, and transfers it to the TES unit 108. The heat transfer fluid containing the heat is transported to the TES unit 108 where a heating medium 112 absorbs thermal energy from the heat transfer fluid. Example fluids for the heat transfer fluid and the heating medium 112 include synthetic oil, molten salt, glycol, water (either liquid or pressurized steam), and other Phase-Change Materials (PCM).

In some implementations, the heating medium 112 may be a PCM to increase the heat capacity or reduce the volume of the TES unit 108 up to ten times, for example. Some salt hydrates, like Sodium Acetate Trihydrate (SAT) based mixture, may be used as a PCM, for example. More specifically, the PCM may be a material that undergoes a phase change (e.g., from liquid to solid or from liquid to gas) to provide additional thermal storage capacity to the TES unit 108. When heated to a melting point, the PCM may change its phase from a solid state to liquid while absorbing heat. The absorbed heat is stored in the salt hydrate until the trigger nucleation occurs. Then, the PCM changes its phase from the liquid state to solid and the latent heat released.

A consumption heat transfer loop 126 containing a second buffer or consumable fluid supplies heat from the TES unit 108 to a consumer and can be either a closed-loop or open-loop pipeline. The thermal energy stored within the TES unit 108 may be consumed directly, such as in a residential heating application. The consumption heat transfer loop 126 transfers thermal energy from the TES unit 108 to the consumer's residence or other structure, such as a barn or workshop, to maintain a comfortable temperature therein, for example.

When the consumption heat transfer loop 126 contains a consumable fluid (e.g., water), the CST system 100 may include a water source (e.g., a well or city water connection) to replace the water within the second consumption heat transfer loop 126 as it is withdrawn by the consumer (e.g., for use of the hot water). When the consumption heat transfer loop 126 contains a heat transfer fluid (e.g., glycol), the consumer is only using the second consumption heat transfer loop 126 for indirect heating (e.g., radiant heating), such as the transfer of heat from the heat transfer loop 126 to another pipe (like a water pipe inside a house), and the fluid within the second consumption heat transfer loop 126 is not regularly replenished.

For an off-grid installation, a control unit 114 can be powered by the sunlight 102, photovoltaic (PV) panels 116, and a battery 118 (other implementations may be powered by other power sources). The control unit 114 includes a pump 120 and associated pump controller 122 that together vary the flow rate of the heat transfer fluid within the supply heat transfer loop 124 to maintain the heat transfer fluid and the heating medium 112 within a desired temperature range, as measured by temperature sensors 128, 130, for example. For example, the desired temperature range is just below the boiling point of the heating medium 112 and/or heat transfer fluids. The angle of the reflector 104 with reference to the sun may also be used to affect the desired temperature range, particularly to prevent the heating medium 112 and/or heat transfer fluids from getting too hot (e.g., by repositioning the reflector 104 away from the sun).

A main control module 132 directs overall operation of the system 100. The main control module 132 has access to weather data, which is either measured locally via attached weather instruments 134 (e.g., anemometer, GPS sun tracker, and other sensors) and/or delivered from a remote source over a data connection 136 (e.g., Wi-Fi). The data connection 136 may also be used to remotely control operation of the system 100 and/or remotely collect data regarding the operation of the system 100. Such data may be stored locally or remotely (e.g., cloud storage). The main control module 132 has control over the pump controller 122 discussed above to direct operation of the pump 120. The main control module 132 further includes slewing drive control to drive rotation of the drive shaft 110 to maintain the focus of the sun rays on the collector 106 as the time-of-day changes.

In various implementations, the control unit 114 may control one or more distinct CST systems, such as CST system 100. Different modes of operating the control unit 114 are also contemplated herein to maximize effective capture of solar thermal energy and transmission of the solar energy to the TES unit 108.

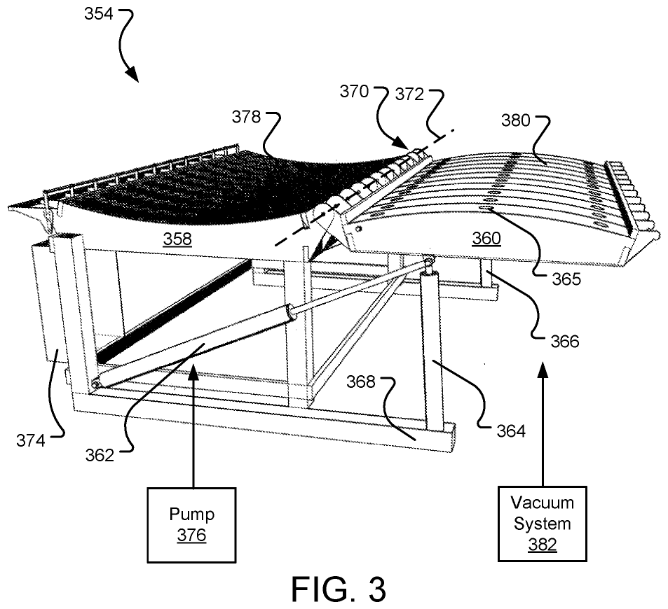

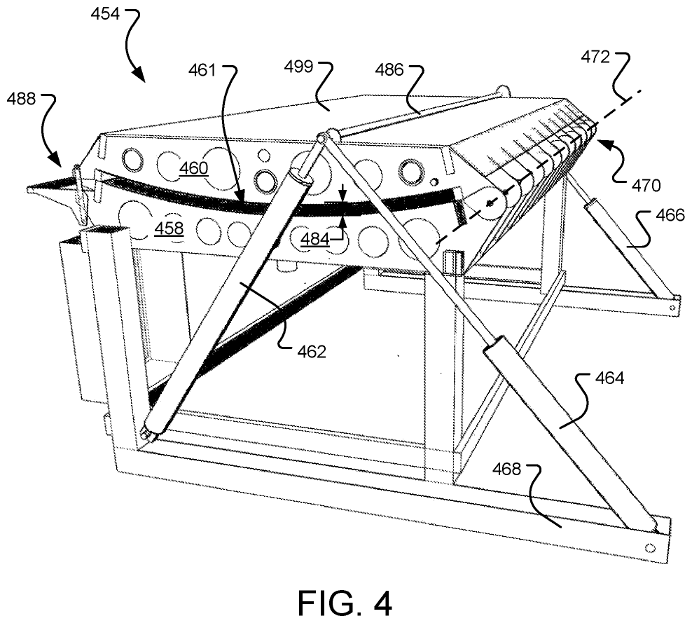

FIG. 2 illustrates a preformed mirror sandwich reflector 256 manufactured using the presently disclosed technology. In various implementations, the preformed mirror sandwich reflector 256 may be formed using the press-form 354, 454 of FIGS. 3 and 4, for example. The reflector 256 is constructed of two panels, a reflector panel 267 (e.g., a reflective acrylic, metal alloy, or glass) and a backer panel 266 (e.g., various plastic or metal alloy materials with no reflective requirement), with a fixed volume therebetween. The panels 266, 267 may be flexible to enable a predefined, and in some cases constant, curvature of the reflector 256, as discussed in detail below. During manufacturing, a liquid closed-cell foam 261 fills the fixed volume between the reflector panel 267 and the backer panel 266. As the closed-cell foam 261 cures, it expands and adheres to the reflector panel 267 and the backer panel 266 and creates a rigid overall structure with a predefined radius of curvature. The completed sandwich mirror reflector 256 is a sandwiched construction of the reflector panel 267, the cured expanded closed-cell foam 261, and the backer panel 266 with a predefined overall radius.

The preformed mirror sandwich reflector 256 may have a curve of various radii or parabolic curvatures about a singular projected center axis parallel to broken line 238. Moving along the broken line 238, the preformed mirror sandwich reflector 256 is substantially linear. This simple curvature eases construction and allows the preformed mirror sandwich reflector 256 to be arranged in-line with other similarly constructed preformed mirror sandwich reflectors extending indefinitely along the broken line 238. In other implementations, the reflector 256 can be substantially planar reflector.

Further, the expanded closed-cell foam may be approximately 25 mm thick (or 5-100 mm thick), the plastic backer panel is 0.6 mm thick (or 0.3-5.0 mm thick), and the acrylic reflector panel is 1.2 mm thick (or 0.01 mm-5 mm thick). This yields an overall thickness of the preformed mirror sandwich reflector 256 ranging from 11-43 mm. These foregoing thickness may vary from that provided depending on the implementation and requirements of the preformed mirror sandwich reflector 256. The width and length of the preformed mirror sandwich reflector 256 may also vary widely, but due to convenience in construction standards, may conform to standard sizes. For example, the preformed mirror sandwich reflector 256 may be approximately 8′ long and 4′ wide. The resulting completed sandwich mirror reflector 256 is lightweight (owing to much of its structure being the rigid closed-cell foam 261), but also structurally rigid (due to the rigid closed-cell foam 261). This allows the completed sandwich mirror reflector 256 to be easily handled and installed, without requiring specialized equipment.

In implementations where the reflector panel 267 is mirror-polished stainless steel or aluminum, it may be thinner than 1 mm acrylic due to its increased unit weight and material strength. In various implementations, the acrylic reflector panel is advantageous in that it is lower cost and has lower thermal conductivity (absorbs less solar energy) than stainless steel. The acrylic reflector panel may further have better light reflectivity, but a shorter lifespan than stainless steel. The reflector panel 267 may further be made of glass or a glass-coated material. Any of the foregoing reflector materials may be implemented using the presently disclosed technology.

FIG. 3 illustrates a press-form (mold) 354 for preformed mirror sandwich reflector (not shown, see e.g., reflector 256 of FIG. 2) production in an open orientation for a Concentrating Solar Thermal (CST) system (not shown, see e.g., CST system 100 of FIG. 1) according to the presently disclosed technology. The press-form 354 is used to make sandwich mirror reflectors with a predefined curvature or radius. The press-form 354 includes frame 368, to which a lower section 358 and an upper section 360 are connected. The lower section 358 is connected to the upper section 360 at hinge 370, which allows for rotation of the upper section 360 with reference to the lower section 358 about axis of rotation 372.

Hydraulic or pneumatic struts (e.g., struts 362, 364, 366) connect the upper section 360 to the frame 368 and either assist or drive changes in rotational position of the upper section 360 with reference to the lower section 358. In the depicted implementation, a pair of struts 362, 364 are positioned on the depicted side of the press-form 354 and a second pair of similar struts (one of which, strut 366, is partially shown) are positioned on the non-depicted side of the press-form 354. In an assist implementation, the struts 362, 364 are used to counteract the weight of the upper section 360 so that a user may physically open and close the press-form 354 with minimal effort. In a powered implementation, the struts 362, 364 drive re-positioning of the upper section 360 with reference to the lower section 358 based on a user input. The press-form 354 may be equipped with a control box 374 that receives the user input, such as “open” or “close.” A hydraulic or pneumatic pump 376 may provide pressurized fluid to the struts 362, 364 based on user input received from the control box 374. In the assist implementation, the pump 376 is omitted and the struts 362, 364 are sealed.

In other implementations, the press-form 354 includes a winch lifting/lowering system in place of the struts 362, 364 and pump 376 to aid in rotating the upper section 360 up/down and wheels for repositioning the press-form 354 or drive the rotating motion. In some implementations, the winch lifting/lowering system includes a counterweight calibrated to mostly offset the weight of the upper section 360 attached to the press-form 354 using metal cable, blocks and pulleys.

The depicted open orientation of FIG. 3 places the upper section 360 at approximately 180-degrees from the lower section 358. In other implementations, the open orientation places the upper section 360 at approximately 90-degrees from the lower section 358. Still further implementations may select a different angular orientation of the upper section 360 with reference to the lower section 358 for the open orientation so long as the interior of the press-form 354 is accessible.

Working surfaces 380, 378 on the upper and lower sections 360, 358, respectively, are used to define the curvature of a layered construction (not shown, see e.g., reflector panel 267, the cured expanded closed-cell foam 261, and the backer panel 266 of FIG. 2). The working surfaces 380, 378 are constructed of a continuous curved panel that occupies the working length and width of the press-form 354 and is supported by stiffening ribs. The curvatures of the working surfaces 380, 378, respectively, defines surface profiles that are in turn applied to each side of the reflector to generate a similar surface profiles on each side of the reflector. In other implementations, the working surfaces 380, 378 include a series of parallel planar panels, which yields a planar surface profile of each of the working surfaces 380, 378. The series of parallel stiffening ribs support working surfaces 380, 378 defining their curvature and providing rigidity to ensure that the press-form 354 does not deform when the closed-cell foam applies pressure while curing during the formation of a sandwich mirror reflector, as discussed with reference to FIG. 4 below.

At least the upper working surfaces 380, and in some implementations, the lower working surface 378, include a series of spaced vents (e.g., vent 365) for application of negative pressure, as discussed further below. A vacuum system 382 (e.g., a vacuum pump and associated controller) is connected to the press-form 354 and applies negative pressure to one or both of the working surfaces 380, 378 via the spaced vents by drawing air through the spaced vents. The vacuum system 382 may be controlled via user input from the control box 374.

When used to create a sandwich mirror reflector (not shown, see e.g., reflector 256 of FIG. 2), a backer panel (also not shown, see e.g., backer panel 266 of FIG. 2) is placed on the lower section 358 and generally held in place against the working surface 378 by gravity. In some implementations, the vacuum system 382 applies negative pressure to the working surface 378 that pulls the backer panel down onto the lower section 358 and holds it in position with a curvature defined by the lower section 358.

A mirror (or reflector) panel (not shown, see e.g., reflector panel 267 of FIG. 2) is placed on the upper section 360. The vacuum system 382 pulls the mirror panel against the working surface 380 of the upper section 360, which holds the reflector panel in place on the upper section 360 with a curvature defined by the upper section 360. The vacuum system 382 further allows the upper section 360 to be repositioned from the depicted open orientation to a closed orientation (see e.g., FIG. 4) without gravity acting on the reflector panel to separate it from the upper section 360.

The respective curvatures or radii of the lower section 358 and the upper section 360 match so that a completed sandwich mirror reflector has the same or similar radius or curvature on its top and its bottom. A closed-cell pour foam is spread, sprayed, or otherwise applied to the backer panel on the lower section 358, and the upper section 360 with the reflector panel attached is closed by rotating about the axis of rotation 372 so that it is situated over the lower section 358, as illustrated in FIG. 4, and discussed below.

FIG. 4 illustrates the press-form 354 of FIG. 3 (press-form 454) in a closed orientation. As compared to the open orientation of FIG. 3, upper section 460 is rotated about axis of rotation 472 at hinge 470 with reference to lower section 458 so that the upper section 460 overlies the lower section 458 with a fixed gap 484 therebetween. While illustrated in FIG. 4, the fixed gap 484 is not viewable from the outside of the press-form 454 as side panels seal the gap to prevent closed-cell pour foam 461 from expanding beyond the press-form 454. Hydraulic or pneumatic struts (e.g., struts 462, 464, 466) that connect the upper section 460 to frame 468 are repositioned to drive or assist movement of the upper section 460 from the open orientation of FIG. 3 to the close orientation of FIG. 4. A reinforcing bar 486 is attached to a rear panel 499 of the upper section 460 and serves as an attachment from the hydraulic struts and distributes their applied force along a length of the upper section 460.

The fixed gap 484 of the closed orientation defines a fixed spaced position of upper section 460 (and its mirror (or reflector) panel, not shown see e.g., reflector 256 of FIG. 2) with reference to the lower section 458 (with its backer panel, also not shown, see e.g., backer panel 266 of FIG. 2). The closed-cell pour foam 461 expands and fills a volume between the reflector panel and the backer panel defined by the fixed gap 484. As the expanded closed-cell foam 461 cures, it adheres to the reflector panel and the backer panel and creates a rigid structure with a predefined radius or curvature that matches that of the upper section 460 and the lower section 458. The result is a completed sandwich mirror reflector (not shown, see e.g., reflector panel 267 of FIG. 2) with a predefined radius or curvature, which is a sandwiched construction of the reflector panel, the cured expanded closed-cell foam, and the backer panel.

The press-form 454 includes a latching mechanism 488 that secures the upper section 460 in the spaced position over the lower section 458 while the closed-cell foam 461 cures. This prevents expansion of the closed-cell foam 461 from lifting the upper section 460 upward.

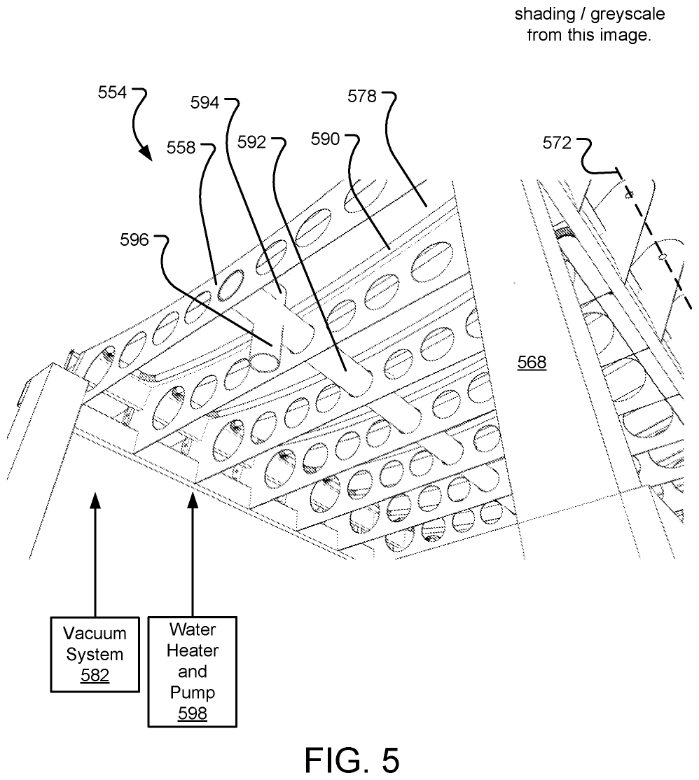

FIG. 5 illustrates a partial underside view showing heating lines 590 and vacuum lines 592 within an example lower section 558 of a press-form (mold) 554 for preformed mirror sandwich reflector production. The press-form 554 is used to make sandwich mirror reflectors (not shown, see e.g., preformed mirror sandwich reflector 256 of FIG. 2) with a predefined curvature or radius. The press-form 554 includes frame 568, to which the lower section 558 and an upper section (not shown, see e.g., upper section 360 of FIG. 3) are connected. The lower section 558 is hinged to the upper section, which allows for rotation of the upper section with reference to the lower section 558 about axis of rotation 572.

A lower working surface 578 on the lower section 558 is used to define a curvature of a layered construction (not shown, see e.g., reflector panel 267, the cured expanded closed-cell foam 261, and the backer panel 266 of FIG. 2). A similar working surface is incorporated into the upper section (not shown, see e.g., working surface 380 on upper section 360 of FIG. 3). The working surfaces are constructed of a continuous curved panel, supported by stiffening ribs, that occupies the working length and width of the press-form 554.

The lower working surface 578 includes a series of spaced vents (not shown, see e.g., vent 365 of FIG. 3) for application of negative pressure via outlets (e.g., outlet 594). A vacuum system 582 (e.g., a vacuum pump and associated controller) is connected to the vacuum lines 592 (e.g., a network of polyvinyl acetate (PVC) lines) at vacuum input 596 (or elsewhere) and applies negative pressure to the lower working surface 578 via the spaced vents. The vacuum system 382 may be controlled via user input from a control box (e.g., control box 374 of FIG. 3). An upper working surface has a similar arrangement of vacuum lines, input(s), and outlet(s) that is functionally similar.

The heating lines 590 (e.g., a loop of corrugated metal alloy lines, such as corrugated stainless steel tubing (CSST), bent into position or set of rigid pipe and associated fittings) run back and forth across the depicted rear surface of the lower working surface 578 and are connected to a water heater and pump 598 or other heated fluid source that circulated heated fluid through the heating lines 590. The heating lines 590 are used to heat the layered construction to ensure the correct chemical reaction and good adhesion to a backer panel and a reflector panel during the curing of the closed-cell foam. The upper working surface has a similar arrangement of heating lines 590 that is functionally similar to apply heat to the upper working surface.

In various implementations, the depicted vacuum lines 592 and heating lines 590 are sealed within the lower section 558 by foam and a rear panel (not shown, see e.g., rear panel 499 of FIG. 4). The foam and rear panel serve to insulate the heating lines 590 and protect both the heating lines 590 and the vacuum lines 592 from damage.

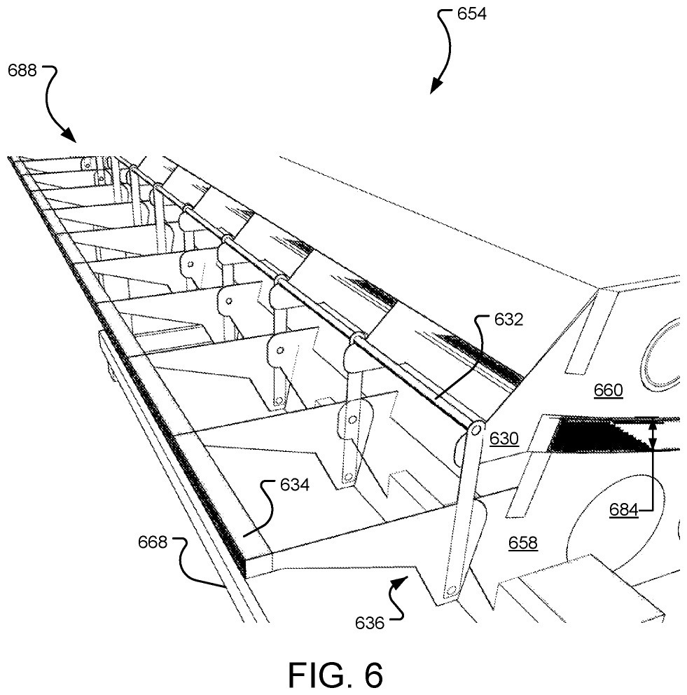

FIG. 6 illustrates an example latching mechanism 688 for a press-form 654 for preformed mirror sandwich reflector production. The press-form 654 is used to make sandwich mirror reflectors (not shown, see e.g., preformed mirror sandwich reflector 256 of FIG. 2) with a predefined curvature or radius. The press-form 654 includes frame 668, to which a lower section 658 and an upper section 660 are connected. The lower section 658 is hinged to the upper section 660, which allows for rotation of the upper section with reference to the lower section 658 so that the upper section 660 overlies the lower section 658 with a fixed gap 684 therebetween. While illustrated in FIG. 6, the fixed gap 684 is not viewable from the outside of the press-form 654 as side panels seal the gap to prevent closed-cell pour foam from expanding beyond the press-form 654

The fixed gap 684 of the closed orientation defines a fixed spaced position of upper section 660 (and its mirror (or reflector) panel, not shown see e.g., reflector 256 of FIG. 2) with reference to the lower section 658 (with its backer panel, also not shown, see e.g., backer panel 266 of FIG. 2). Closed-cell pour foam (not shown see e.g., closed-cell pour foam 261 of FIG. 2) expands and fills a volume between the reflector panel and the backer panel defined by the fixed gap 684. As the expanded closed-cell foam 461 cures, it adheres to the reflector panel and the backer panel and creates a rigid structure with a predefined radius or curvature that matches that of the upper section 660 and the lower section 658. The result is a completed sandwich mirror reflector (not shown, see e.g., reflector panel 267 of FIG. 2) with a predefined radius, which is a sandwiched construction of the reflector panel, the cured expanded closed-cell foam, and the backer panel.

The latching mechanism 688 secures the upper section 660 in position over the lower section 658 and maintains the fixed gap 684 while the closed-cell foam 461 cures. This prevents expansion of the closed-cell foam from lifting the upper section 660 upward. The latching mechanism 688 includes a series of receivers (e.g., receiver 630) and a latching rod 632 that runs a length of the press-form 654. The latching rod 632 is connected to a handle 634 that also runs the length of the press-form 654 via a series of hinged cam mechanisms (e.g., cam mechanism 636), one for each receiver, that provide mechanical advantage to a user operating the latching mechanism 688. The series of receivers and hinged cam mechanisms working with the latching rod 632 evenly distributes force across the width of the press-form 654. A variety of other latching mechanisms are contemplated herein that accomplish a similar result.

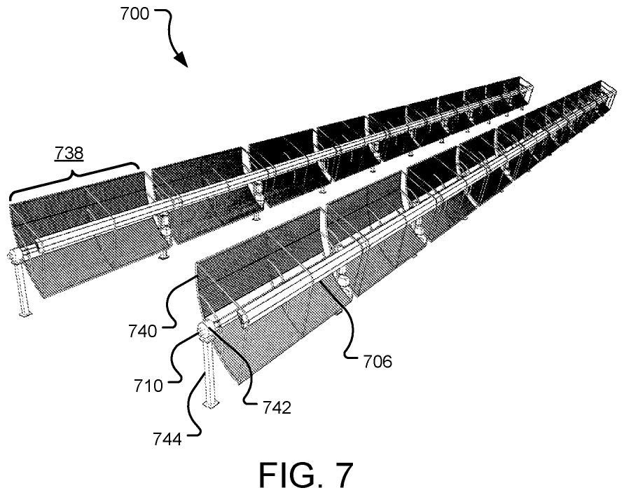

FIG. 7 illustrates an example installation of a Concentrating Solar Thermal (CST) system 700 according to the presently disclosed technology. By design, presently disclosed CST technology is modular and scalable. The depicted CST system 700 includes three rows of eight individual solar modules (e.g., solar module 738). Each individual solar module may be 16 feet long and built out of commonly available materials. Therefore, the presently disclosed technology is fast to manufacture, easy to customize, install, and transport, and low in cost. Each solar module includes a curved frame (e.g., frame 740), which can be made up of square tubing, supporting corrugated metal sheeting that serves to position and stabilize a pre-formed mirror sandwich reflector (not shown) attached overtop of the corrugated metal sheeting. The curved frames and associated corrugated sheet metal further hold and protect the reflectors, collectors, and collector housings, including insulation, and tempered glass covers. In various implementations, the solar modules are modular and have dimensions that are commonly available for building materials (e.g., 16 feet long). The solar modules are also durable, rigid, and may be sufficiently strong to withstand extreme weather conditions (e.g., hail, wind, and/or snow).

Each row of solar modules is suspended on a drive shaft (e.g., drive shaft 710) that allows a tracking system (not shown, see e.g., control unit 114 of FIG. 1) to follow the position of the sun. The drive shafts are suspended on bearings (e.g., bearing 742) mounted on posts (e.g., post 744) that are secured to the ground. The bearings enable the drive shafts to rotate the solar modules and allow the focal line of each reflector to remain on a corresponding collector (e.g., collector 706) throughout the day.

The solar modules are also engineered to be installed, disassembled, transported, and re-installed elsewhere using commonly available hand tools, construction techniques, and equipment. For example, solar modules may be structurally independent and capable of being slid or otherwise attached to the drive shafts independently (e.g., to replace a damaged solar module). The reflectors are also independently attached to the solar modules so that they may be replaced without disassembling the solar modules.

In an example implementation, the solar modules can be rotated (e.g., so that they face vertically) to aid in removal of damaged reflectors and/or installation of replacement reflectors. Further, each of the solar modules may include retaining channels that allow the reflectors to be slid into place on a solar module. A minimum of fasteners, if necessary, are then used to secure the reflectors in place. This allows the reflectors to be changed within 30 seconds, for example.

In various implementations, the solar collectors for the solar modules are protected from heat loss by insulation and the metal housing on the outside and tempered ultra-transparent glass on the side of the reflector. Further, the solar collectors may be painted in matte black and have a black screen underneath for improved heat absorption. Each individual solar module has its own solar collector that may be connected to the next solar module section in line by Corrugated Stainless Steel Tubing (CSST). This allows for compensation of thermal expansion and provides structural independence of solar modules and aids scalability of the system 700. The solar collectors may be made of two parallel rectangular tubes, each with an inlet and outlet on one (same) side that makes the heat transfer fluid flow twice through the solar collector, accumulating more thermal energy. This may simplify the installation, increase efficiency, and reduce heat loss for the system 700.

In some implementations, each end of a row of solar modules is supplied with additional mirrors (not shown) located between the solar collector and the central axis. These mirrors reflect the peripheral sun rays on the solar collector during the morning and evening hours, which increases the efficiency of the system 700. Still further, the solar reflector of each individual solar module may include four sandwiched mirror reflector panels to simplify fabrication, installation, and maintenance. For example, this may render the solar reflector better able to withstand wind loads and prevent the mirrors from being disabled by a shadow from the solar collector. The solar reflectors may be designed with gaps between the upper and lower segments of the reflector to allow wind to flow therethrough and aid installation and replacement as needed.

The depicted three rows of eight solar modules in each row is one example of the presently disclosed technology that may be scaled up or down by adding or removing rows or individual solar modules within each row. The depicted and described three-row CST of twenty-four solar thermal modules in total may be adequately sized to supply the entire heating and hot water needs of a 10,000 sq. ft. dwelling, for example.

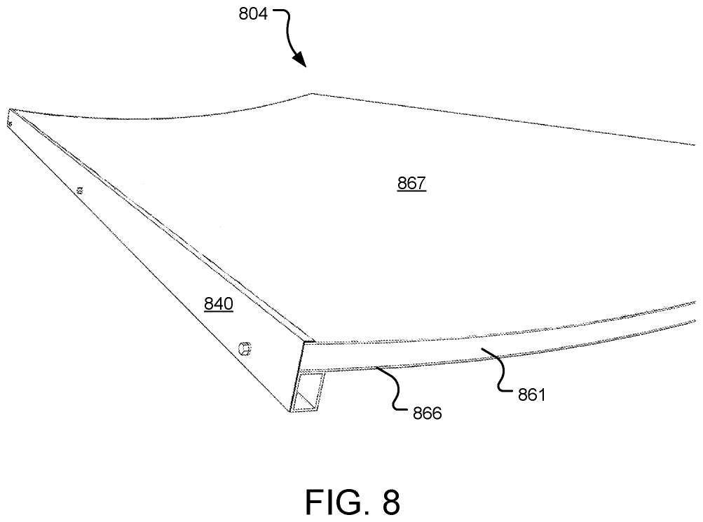

FIG. 8 illustrates a reflector 804 installation for a Concentrating Solar Thermal (CST) system according to the presently disclosed technology. During manufacturing, a liquid closed-cell foam 861 fills the fixed volume between reflector panel 867 and backer panel 866. As the closed-cell foam 861 cures, it expands and adheres to the reflector panel 867 and the backer panel 866 and creates a rigid overall structure with a predefined radius of curvature. The completed reflector 804 is a sandwiched construction of the reflector panel 867, the cured expanded closed-cell foam 861, and the backer panel 866 with a predefined overall radius or curvature.

The reflector 804 is pre-shaped to a particular radius or curvature to secure the precise focus of sun rays on a solar collector (not shown). The reflector 804 corresponds with an arcuate shape of an underlying sheet of corrugated metal (not shown), that is supported by a square tubing frame (also not shown, see e.g., frame 740 of FIG. 7). The reflector 804 is attached to the corrugated metal and/or square tubing frame using a retaining channel 840, in combination with clips, screws, or other fasteners. The retaining channel 840 provides a rigid structure for attachment to the corrugated metal or the square tubing frame of the CST system.

For other implementations, different installation mechanisms or methods are used. For example, the reflector 804 may include rear-facing brackets for a rear attachment to an underlying framework. Additional implementations may use glue or other adhesives, clamps, clips, etc. to attach a series of reflectors to an underlying framework.

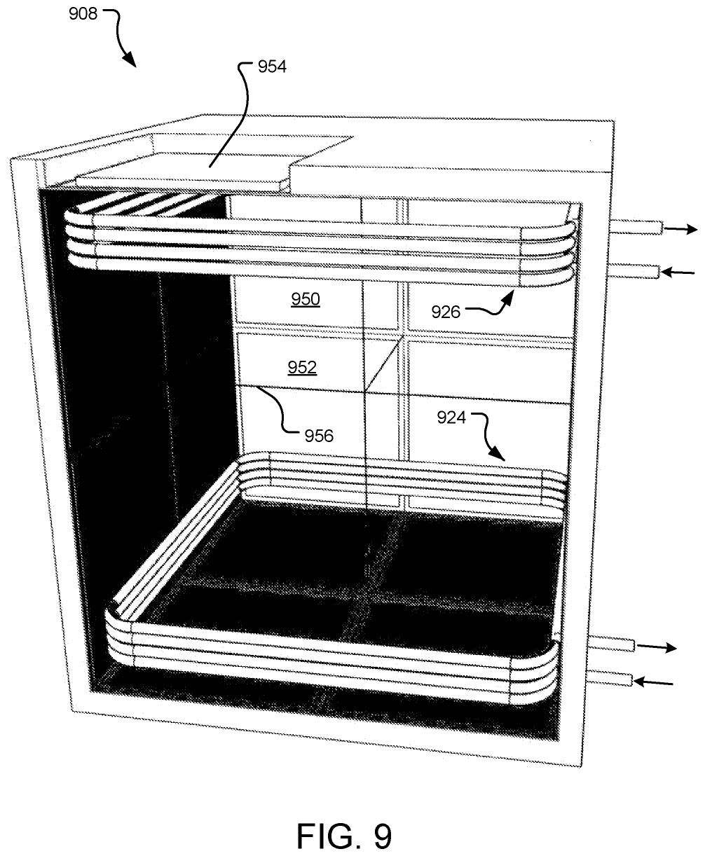

FIG. 9 illustrates a thermal energy storage reservoir 908 for a Concentrating Solar Thermal (CST) system according to the presently disclosed technology. The reservoir 908 is illustrated in FIG. 9 with a front side omitted so that internal components of the reservoir 908 are shown. The reservoir 908 may be modular in that it is made up of a number of panels (e.g., panels 950, 952) that are attached together to form a reservoir of a desired size that allows easy customization and scalability. As an example, the reservoir 908 may be 100 m³ in volume, and constructed of nine panels long, four panels wide, and two panels tall. The panels may be made out of stamped stainless-steel (SS), 304 or 316 grade, and have one or more consistent sizes (e.g., two sizes: 1 square meter for short panels, such as short panel 950, and 1 meter by 2 meters for tall panels, such as tall panel 952).

In various implementations, the panels are relatively low cost, have high availability, are durable, and generally easy to assemble in a modular fashion. Further, the exterior of the reservoir 908 may be covered with moisture-resistant closed-cell spray foam insulation, or other insulation (e.g., wrapped, sprayed, rigid panels) and a UV protective coating (e.g., paint) or a cover/tent to maximize retention of heat within the reservoir 908 and minimize exterior corrosion or other degradation over time. Other panel sizes, shapes, and construction materials are contemplated herein.

The panels are attached together in a fluid tight manner (e.g., with sealing gaskets) to form the reservoir 908 containing a heating medium fluid. For extra water tightening, the interior of the reservoir 908 can be coated with polyurea or other sealant. A heat transfer loop 924 serves to circulate a supply heat transfer fluid between the reservoir 908 and one or more corresponding collectors to pull thermal energy from the collectors into the heat transfer fluid, and further into the heating medium within the reservoir 908. A consumption heat transfer loop 926 serves to circulate a consumption heat transfer fluid between the reservoir 908 and a consumer's residence or other point of use and delivers the thermal energy pulled from the heating medium so that thermal energy generated by the CST system can be used by a consumer.

The heat transfer loops 924, 926 (within the tank and extending outward to the corresponding collectors/consumer may be made of Corrugated Stainless Steel Tubing (CSST) that has a larger wetted surface area for the same length compared to non-corrugated pipes and allows easy installation and connections between portions of the heat transfer loops 924, 926 due to its capability of being bent by hand (e.g., to a minimum radius up to 3 inches), fast fastening methods, and by not requiring exact alignment between portions. The heat transfer loops 924, 926 may further be made of rigid smooth tubing (e.g., metal pipe), flexible tubing (e.g., corrugated metal tubing), or any combination thereof. Flexible tubing may allow for easier connections between portions of the heat transfer loops 924, 926 than rigid tubing (e.g., by not requiring exact alignment between portions of the heat transfer loops 924, 926). The heat transfer loops 924, 926 may be coiled around an interior perimeter of the reservoir 908 and secured within the reservoir 908 to facilitate conductive heat transfer to the reservoir medium that will be stored therein when completed and filled. While four wraps for each of the heat transfer loops 924, 926 is shown, two to twenty wraps may be similarly applied.

A removable and resealable hatch 954 may be provided to provide access to the interior of the reservoir for maintenance. The reservoir 908 may also include a supporting internal framework 956, not shown, to provide a desired level of structural rigidity to a modular arrangement of panels forming the reservoir 908. The supporting internal framework 956 may be round or square tubing that is attached at its ends to opposing walls, with clips attaching the tubing together as one member passes adjacent to another member of the supporting internal framework 956, for example.

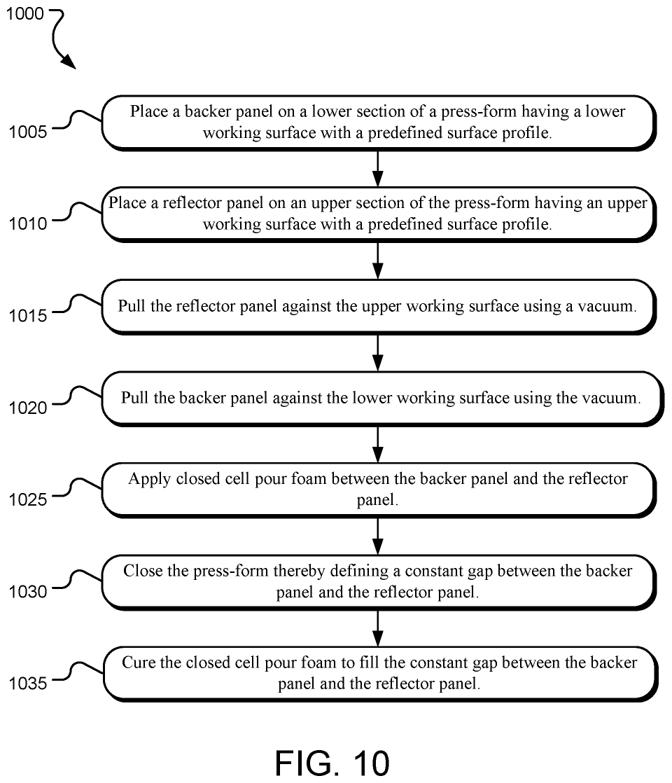

FIG. 10 illustrates example operations 1000 for manufacturing a preformed sandwich mirror reflector. A first placing operation 1005 places a backer panel on a lower section of a press-form having a lower working surface with a predefined surface profile. A second placing operation 1010 places a reflector panel on an upper section of the press-form having an upper working surface with a predefined surface profile. A first pulling operation 1015 pulls the reflector panel against the upper working surface using a vacuum. A second pulling operation 1020 pulls the backer panel against the lower working surface using the vacuum.

An applying operation 1025 applies closed-cell pour foam between the backer panel and the reflector panel (e.g., via spraying or spreading the uncured foam). A closing operation 1030 closes the press-form thereby defining a predefined, and in some cases constant, gap between the backer panel and the reflector panel. A curing operation 1035 cures the closed-cell pour foam to fill the gap between the backer panel and the reflector panel, adhere to the backer panel and the reflector panel, and define a surface profile of the reflector panel.

Implementations of the technology described herein may be implemented as logical steps in one or more computer systems, such as the control unit 114. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, the logical operations may be performed in any order, adding or omitting operations as desired, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A preformed sandwich mirror reflector comprising:
a backer panel;
a reflector panel arranged parallel to the backer panel; and
a cured closed-cell foam adhered to the backer panel and the reflector panel, the cured closed-cell foam having a predefined thickness between the backer panel and the reflector panel, the cured closed-cell foam defining a predefined curvature of the backer panel and the reflector panel, the predefined curvature of the backer panel being parallel to the predefined curvature of the reflector panel.

2. The preformed sandwich mirror reflector of claim 1, wherein the predefined curvature is defined by a simple curve about a center axis of curvature projected away from the preformed sandwich mirror reflector.

3. An arrangement of the preformed sandwich mirror reflectors of claim 1.

4. The arrangement of the preformed sandwich mirror reflectors of claim 1, further comprising:
an arrangement of collectors, each of the reflectors and the collectors mounted on a drive shaft and rotatable to track the sun;
a control unit;
a thermal energy storage unit containing a heating medium;
a supply heat transfer loop containing a first heat transfer fluid running from the collectors to the thermal energy storage unit and including one or more loops in a bottom part of the thermal energy storage unit; and
a consumption heat transfer loop containing a second heat transfer fluid running from the thermal energy storage unit to a consumer, the second heat transfer loop including one or more loops in a top part of the thermal energy storage unit.

5. The preformed sandwich mirror reflector of claim 1, wherein the reflector panel is made of polished acrylic, stainless steel, or glass.

6. A press-form for manufacturing preformed mirror sandwich reflectors comprising:
a lower section having a lower working surface with a predefined surface profile; and
an upper section rotatable with reference to the lower section, the upper section having an upper working surface with the predefined surface profile, the upper section hinged to the lower section, wherein in an open orientation of the press-form the upper and lower working surfaces are accessible and in a closed orientation of the press-form the upper and lower working surfaces face one another with a predefined gap defined therebetween.

7. The press-form of claim 6, where the predefined surface profile is defined by a simple curve about a center axis of curvature projected away from one or both of the upper and lower working surfaces.

8. The press-form of claim 6, where the predefined surface profile is planar.

9. The press-form of claim 6, further comprising:
a latching mechanism to selectively secure the press-form in the closed orientation.

10. The press-form of claim 6, further comprising:
a heating loop applied to a rear-facing side of one or both of the lower working surface and the upper working surface;
a heater to heat a working fluid; and
a pump to circulate the working fluid through the heating loop to heat one or both of the lower working surface and the upper working surface.

11. The press-form of claim 6, further comprising:
a set of vacuum lines within one or both of the lower section and the upper section;
a set of spaced vents in one or both of the lower working surface and the upper working surface, the vents connected to the set of vacuum lines;
a vacuum pump to draw air through the spaced vents in one or both of the lower working surface and the upper working surface.

12. The press-form of claim 6, further comprising:
a frame for securing the lower section in a fixed position;
one or more hydraulic struts connecting the frame to the upper section, wherein the upper section is rotatable with reference to the lower section.

13. The press-form of claim 12, wherein the hydraulic struts assist a user in moving the upper section between the open orientation and the closed orientation.

14. The press-form of claim 12, further comprising:
a hydraulic pump connected to the hydraulic struts, the hydraulic struts to drive motion of the upper section between the open orientation and the closed orientation.

15. The press-form of claim 6, wherein in the open orientation, the upper section is oriented 90-degrees to 180-degrees from the lower section.

16. A method of manufacturing a preformed sandwich mirror reflector comprising:
placing a backer panel on a lower section of a press-form having a lower working surface with a predefined surface profile;
placing a reflector panel on an upper section of the press-form having an upper working surface with a predefined surface profile;
pulling the reflector panel against the upper working surface using a vacuum;
applying closed-cell pour foam between the backer panel and the reflector panel;
closing the press-form thereby defining a predefined gap between the backer panel and the reflector panel; and
curing the closed-cell pour foam to fill the predefined gap between the backer panel and the reflector panel, adhere to the backer panel and the reflector panel, and define a surface profile of the reflector panel.

17. The method of claim 16, further comprising:
pulling the backer panel against the lower working surface using the vacuum.

18. The method of claim 16, where the surface profile of the reflector panel is defined by a simple curve about a center axis of curvature projected away from one or both of the upper and lower working surfaces.

19. The method of claim 16, where the surface profile of the reflector panel is planar.

20. The method of claim 16, wherein the reflector panel is made of polished acrylic, stainless steel, or glass.
